(19) United States
(12) Patent Application Publication
(10) Pub. No.: US 2009/0110245 A1
(43) Pub. Date: Apr. 30, 2009

(54) SYSTEM AND METHOD FOR RENDERING AND SELECTING A DISCRETE PORTION OF A DIGITAL IMAGE FOR MANIPULATION

(76) Inventor: Karl Ola THORN, Malmo (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/928,128

(22) Filed: Oct. 30, 2007

(51) Int. Cl. G06K 9/00; G06K 9/68

(52) U.S. Cl. 382/118; 382/218

(57) ABSTRACT

A system enables a user viewing a digital image rendered on a display screen to select a discrete portion of the digital image for manipulation. The system comprises the display screen and a user monitor digital camera having a field of view directed towards the user. An image control system drives rendering of the digital image on the display screen. An image analysis module determines a plurality of discrete portions of the digital image which may be subject to manipulation. A indicator module receives a sequence of images from a user monitor digital camera and repositions an indicator between the plurality of discrete portions of the digital image in accordance with motion detected from the sequence of images. Exemplary manipulations may comprise red eye removal and/or application of text tags to the digital image.

### TECHNICAL FIELD OF THE INVENTION

The present invention relates to rendering and selecting a discrete portion of a digital image for manipulation, and particularly, to systems and methods for providing a user interface for facilitating rendering of a digital image thereon, selecting a discrete portion of the digital image for manipulation, and performing such manipulation.

### DESCRIPTION OF THE RELATED ART

Contemporary digital cameras typically include embedded digital photo album or digital photo management applications in addition to traditional image capture circuitry. Further, as digital imaging circuitry has become less expensive, other portable devices, including mobile telephones, portable data assistants (PDAs), and other mobile electronic devices often include embedded image capture circuitry (e.g. digital cameras) and digital photo album or digital photo management applications in addition to traditional mobile telephony applications.

Popular digital photo management applications include several photograph manipulation functions for enhancing photo quality, such as correction of red-eye effects, and/or creating special effects. Another popular digital photo management manipulation function is a function known as text tagging.

Text tagging is a function wherein the user selects a portion of the digital photograph, or an image depicted within the digital photograph, and associates a text tag therewith. When viewing digital photographs the “text tag” provides information about the photograph—effectively replacing an age old process of hand writing notes on the back of a printed photograph or in the margins next to a printed photograph in a photo album. Digital text tags also provide an advantage in that they can be easily searched to enable locating and organizing digital photographs within a database.

When digital photo management applications are operated on a traditional computer with a traditional user interface (e.g. full QWERTY keyboard, large display, and a convenient pointer device such as a mouse), applying text tags to photographs is relatively easy. The user simply utilizes the pointer device to select a point within the displayed photograph, mouse-clicks to “open” a new text tag object, types the text tag, and mouse-clicks to apply the text tag to the photograph.

A problem exists in that portable devices such as digital cameras, mobile telephones, portable data assistants (PDAs), and other mobile electronic devices typically do not have such a convenient user interface. The display screen is much smaller, the keyboard has a limited quantity of keys (typically what is known as a “12-key” or “traditional telephone” keyboard), and the pointing device—if present at all—may comprise a touch screen (or stylus activated panel) over the small display or a 5 way multi-function button. This type of user interface makes the application of text tags to digital photographs cumbersome at best.

In a separate field of art, eye tracking and gaze direction systems have been contemplated. Eye tracking is the process of measuring the point of gaze and/or motion of the eye relative to the head. Non-computerized eye tracking systems have been used for psychological studies, cognitive studies, and medical research since the 19^{th} century. The most common contemporary method of eye tracking or gaze direction detection comprises extracting the eye position relative to the head from a video image of the eye.

It is noted that the term eye tracking refers to a system mounted to the head which measures the angular rotation of the eye with respect to the head mounted measuring system. Gaze tracking refers to a fixed system (not fixed to the head) which measures gaze angle—which is a combination of angle of head with respect to the fixed system plus the angular rotation of the eye with respect to the head. It should also be noted that these terms are often used interchangeably.

Computerized eye tracking/gaze direction detection (GDD) systems have been envisioned for driving movement of a cursor on a fixed desk-top computer display screen. For example, U.S. Pat. No. 6,637,883 discloses mounting of a digital camera on a frame resembling eye glasses. The digital camera is very close to, and focus on the user's eye from a known and calibrated position with respect to the user's head. The frame resembling eye glasses moves with the user's head and assures that the camera remains at the known and calibrated position with respect to the user's pupil—even if the user's head moves with respect to the display. Compass and level sensors detect movement of the camera (e.g. movement of the user's entire head) with respect to the fixed display. Various systems then process the compass and level sensor data in conjunction with the image of the user's pupil—specifically the image of light reflecting form the user's pupil to calculate what portion of the computer display the user's gaze is focused. The mouse pointer is positioned at such point.

U.S. Pat. No. 6,659,611 utilizes a combination of two cameras—neither of which needs to be calibrated with respect to the user's eye. The camera's fixed with respect to the display screen. A “test pattern” of illumination is directed towards the user's eyes. The image of the test pattern reflected from the user's cornea is processed to calculate what portion of the computer display the user's gaze is focused.

Although use GDD to position a pointer on a display screen (at the point of gaze) have been envisioned, no such systems are in wide spread use in a commercial application. There exist several challenges with commercial implementation. First, multiple cameras positioned at multiple calibrated positions with respect to the computer display and/or with respect to the user's eye are cumbersome to implement. Second, significant calibration computations and significant multi-dimension coordinate calculations are required to overcome relative movement of the user's head with respect to the display, relative movement of the user's eyes within the user's eye sockets and with respect to the user's head—such calculations require significant processing power. Third, due to the quantity of variables and the precision of angular measurements, determining the point on the display where the user's gaze is directed can not be calculated with a commercially acceptable degree of accuracy or precision.

It must also be appreciated that the above described patents do not teach of suggest implementing GDD on a hand held device wherein the distance, and angles, of the display with respect to the user is almost constantly in motion. Further, the challenges described above would make implementation of GDD on a portable device even more impractical. First, the processing power of a portable device is typically constrained by size, heat management, and power management requirements. A typical portable device has significantly less processing power than a fixed computer and significantly less processing power than would be required to reasonably implement GDD calculations. Further, while certain inaccuracies in determining position of a user's gaze within three-dimensional space, for example 10 mm, may be acceptable if user is gazing at a large display, a similar imprecision may represent a significant portion of the small display of a portable device—thereby rending such a system useless.

As such, GDD systems do not provide a practical solution to the problems discussed above. What is needed is a system and method that provides a more convenient means for rendering a digital photograph on a display, selecting a discrete portion of the digital photograph for manipulation, and performing such manipulation—particularly on the small display screen of a portable device.

### SUMMARY

A first aspect of the present invention comprises a system for enabling a user viewing a digital image rendered on a display screen to select a discrete portion of the digital image for manipulation. The digital image may be a stored photograph or an image being generated by a camera in a real time manner such that the display screen is operating as a view finder (image is not yet stored). The system comprises the display screen and a user monitor digital camera having a field of view directed towards the user.

An image control system drives rendering of the digital image on the display screen. An image analysis module determines a plurality of discrete portions of the digital image which may be subject to manipulation.

An indicator module receives a sequence of images from the user monitor digital camera and repositions an indicator between the plurality of discrete portions of the digital image in accordance with motion detected from the sequence of images. The motion may be detecting movement of an object by means of object recognition, edge detection, silhouette recognition or other means.

In one embodiment, the user monitor digital camera may have a field of view directed towards the user's face. As such, the indicator module receives a sequence of images from the user monitor digital camera and repositions an indicator between the plurality of discrete portions of the digital image in accordance with motion of at least a portion of the user's face as detected from the sequence of images. This may include motion of the user's eyes as detected from the sequence of images.

In another embodiment of this first aspect, repositioning the indicator between the plurality of discrete portions may comprise: i) determining a direction vector corresponding to a direction of the detected motion of at least a portion of the user's face; and ii) snapping the indicator from a first of the discrete portions to a second of the discrete portions wherein the second of the discrete portions is positioned, with respect to the first of the discrete portions, in the same direction as the direction vector.

In another embodiment of this first aspect, each of the discrete portions of the digital image may comprise an image depicted within the digital image meeting selection criteria. As such, the image analysis module determines the plurality of discrete portions of the digital image by identifying, within the digital image, each depicted image which meets the selection criteria. In a sub embodiment, the selection criteria may be facial recognition criteria such that each of the discrete portions the digital image is a facial image of a person.

In yet another embodiment of this first aspect, the image control system may further: i) obtain user input of a manipulation to apply to a selected portion of the digital image; and ii) apply the manipulation to the digital image. The selected portion of the digital image may be the one of the plurality of discrete portions identified by the indicator at the time of obtaining user input of the manipulation.

Exemplary manipulation may comprise correction red-eye on a facial image of a person within the selected portion and/or application of a text tag to the selected portion of the digital image.

In yet another embodiment wherein the digital image is a portion of a motion video, the manipulation applied to the selected portion may remain associated with the same image in subsequent portions of the motion video.

In an embodiment wherein the manipulation comprises application of a text tag, the system may further comprise an audio circuit for generating an audio signal representing words spoken by the user. In such embodiment, association the text tag with the selected portion of the digital image may comprise: i) a speech to text module receiving at least a portion of the audio signal representing words spoken by the user; and ii) performing speech recognition to generate a text representation of the words spoken by the user. The text tag comprises the text representation of the words spoken by the user.

In yet another embodiment of this first aspect, the system may be embodied in a battery powered device which operates in both a battery powered state and a line powered state. As such, if the system is in the battery powered state when receiving at least a portion of the audio signal representing words spoken by the user, then the audio signal may be saved. When the system is in a line powered state: i) the speech to text module may retrieve the audio signal and perform speech recognition to generate a text representation of the words spoken by the user; and ii) the image control system may associate the text representation of the words spoken by the user with the selected portion of the digital image as the text tag.

A second aspect of the present invention comprises a method of operating a system for enabling a user viewing a digital image rendered on a display screen to select a discrete portion of a digital image for manipulation. The method comprises: i) rendering the digital image on the display screen; ii) determining a plurality of discrete portions of the digital image which may be subject to manipulation; and iii) receiving a sequence of images from the user monitor digital camera and repositioning an indicator between the plurality of discrete portions of the digital image in accordance with motion detected from the sequence of images.

Again, the digital image may be a stored photograph or an image being generated by a camera in a manner such that the display screen is operating as a view finder. Again, the motion may be detecting movement of an object by means of object recognition, edge detection, silhouette recognition or other means.

Again, repositioning of the indicator between the plurality of discrete portions of the digital image may be in accordance with motion of at least a portion of the user's face as detected from the sequence of images

In another embodiment, repositioning an indicator between the plurality of discrete portions may comprise: i) determining a direction vector corresponding to a direction of the detected motion of at least a portion of the user's face; and ii) snapping the indicator from a first of the discrete portions to a second of the discrete portions wherein the second of the discrete portions is positioned, with respect to the first of the discrete portions, in the same direction as the direction vector.

In another embodiment, each of the discrete portions of the digital image may comprise an image depicted within the digital image meeting selection criteria. In such embodiment, determining the plurality of discrete portions of the digital image may comprise initiating an image analysis function to identify, within the digital image, each image meeting the selection criteria. An example of selection criteria may be facial recognition criteria—such that each of the discrete portions the digital image includes a facial image of a person.

In another embodiment, the method may further comprise: i) obtaining user input of a text tag to apply to a selected portion of the digital image, and ii) associating the text tag with the selection portion of the digital image. The selected portion of the digital image may be the discrete portion identified by the indicator at the time of obtaining user input of the manipulation.

To obtain user input of the text tag, the method may further comprise generating an audio signal representing words spoken by the user and detected by a microphone. Associating the text tag with the selected portion of the digital image may comprise performing speech recognition on the audio signal to generate a text representation of the words spoken by the user. The text tag comprises the text representation of the words spoken by the user.

In yet another embodiment wherein the method is implemented in a battery powered device which operates in both a battery powered state and a line powered state, the method may comprise generating and saving at least a portion of the audio signal representing words spoken by the user. When the device is in a line powered state, the steps of: performing speech recognition to generate a text representation of the words spoken by the user; and ii) associating the text representation of the words spoken by the user with the selected portion of the digital image, as the text tag, may be performed.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

FIG. 1 is a diagram representing an exemplary system and method for rendering of, and manipulation of, a digital image on a display device in accordance with one embodiment of the present invention;

FIG. 2 is a diagram representing an exemplary system and method for rendering of, and manipulation of, a digital image on a display device in accordance with a second embodiment of the present invention;

FIG. 3 is a diagram representing an exemplary element stored in a digital image database in accordance with one embodiment of the present invention;

FIG. 4 is a flow chart representing exemplary steps performed in rendering of, and manipulation of, a digital image on a display device in accordance with one embodiment of the present invention

FIG. 5a is a flow chart representing exemplary steps performed in rendering of, and manipulation of, a digital image on a display device in accordance with a second embodiment of the present invention;

FIG. 5b is a flow chart representing exemplary steps performed in rendering of, and manipulation of, a digital image on a display device in accordance with a second embodiment of the present invention; and

FIG. 6 is a diagram representing an exemplary embodiment of the present invention applied to motion video.

### DETAILED DESCRIPTION OF EMBODIMENTS

The term “electronic equipment” as referred to herein includes portable radio communication equipment. The term “portable radio communication equipment”, also referred to herein as a “mobile radio terminal” or “mobile device”, includes all equipment such as mobile phones, pagers, communicators, e.g., electronic organizers, personal digital assistants (PDAs), smart phones or the like.

Many of the elements discussed in this specification, whether referred to as a “system” a “module” a “circuit” or similar, may be implemented in hardware circuit(s), a processor executing software code, or a combination of a hardware circuit and a processor executing code. As such, the term circuit as used throughout this specification is intended to encompass a hardware circuit (whether discrete elements or an integrated circuit block), a processor executing code, or a combination of a hardware circuit and a processor executing code, or other combinations of the above known to those skilled in the art.

In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

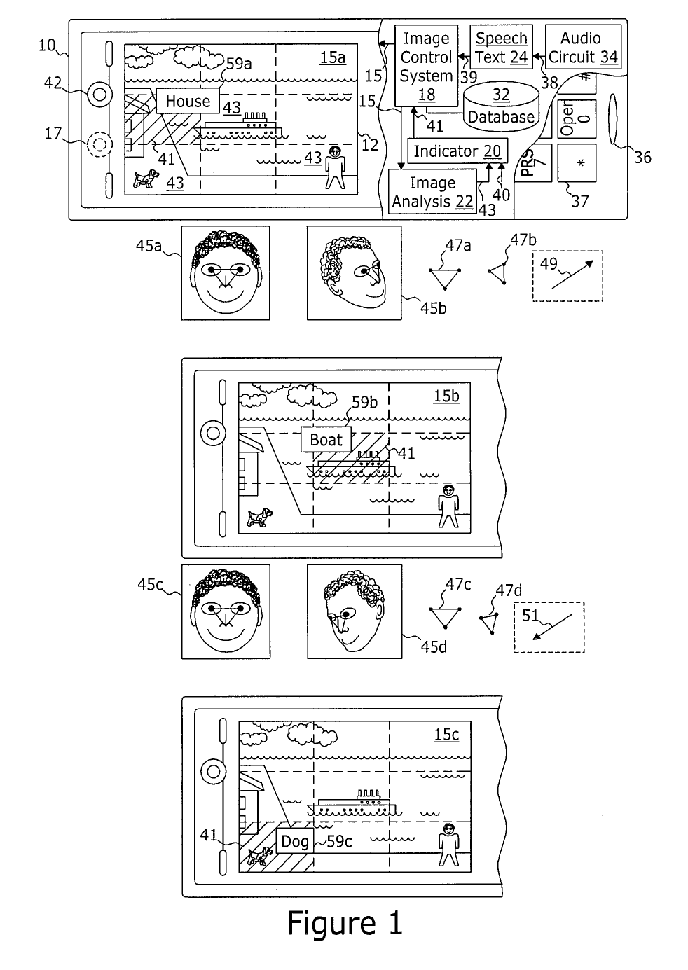

With reference to FIG. 1, an exemplary device 10 is embodied in a digital camera, mobile telephone, mobile PDA, or other mobile device with a display screen 12 for rendering of information and, particularly for purposes of the present invention, rendering a digital image 15 (represented by digital image renderings 15a, 15b, and 15c).

To enable rendering of the digital image 15, the mobile device 10 may include a display screen 12 on which a still and/or motion video image 15 (represented renderings 15a, 15b, and 15c on the display screen 12) may be rendered, an image capture digital camera 17 (represented by hidden lines indicating that such image capture digital camera 17 is on the backside of mobile device 10) having a field of view directed away from the back side of the display screen 12 for capturing still and/or motion video images 15 in an manner such that the display screen may operate as a view finder, a database 32 for storing such still and/or motion video images 15 as digital photographs or video clips, and an image control system 18,

The image control system 18 drives rendering of an image 15 on the display screen 12. Such image may be any of: i) a real time frame sequence from the image capture digital camera 17 such that the display screen 12 is operating as a view finder for the image capture digital camera 17; or ii) a still or motion video image obtained from the database 32.

The image control system 18 may further implement image manipulation functions such as removing red-eye effect or adding text tags to a digital image. For purposes of implementing such manipulation functions, the image control system 18 may interface with an image analysis module 22, a indicator module 20, and a speech to text module 24.

In general, the image analysis module 22 may, based on images depicted within the digital image 15 rendered on the display 12, determine a plurality of discrete portions 43 of the digital image 15 which are commonly subject to user manipulation such red-eye removal and/or text tagging. It should be appreciated that although the discrete portions 43 are represented as rectangles, other shapes and sizes may also be implement—for example polygons or even individual pixels or groups of pixels. Further, although the discrete portions 43 are represented by dashed lines in the diagram—in an actual implementation, such lines may or may not be visible to the user.

In more detail, the image analysis module 22 locates images depicted within the digital image 15 which meet selection criteria. The selection criteria may be any of object detection, face detection, edge detection, or other means for locating an image depicted within the digital image 15.

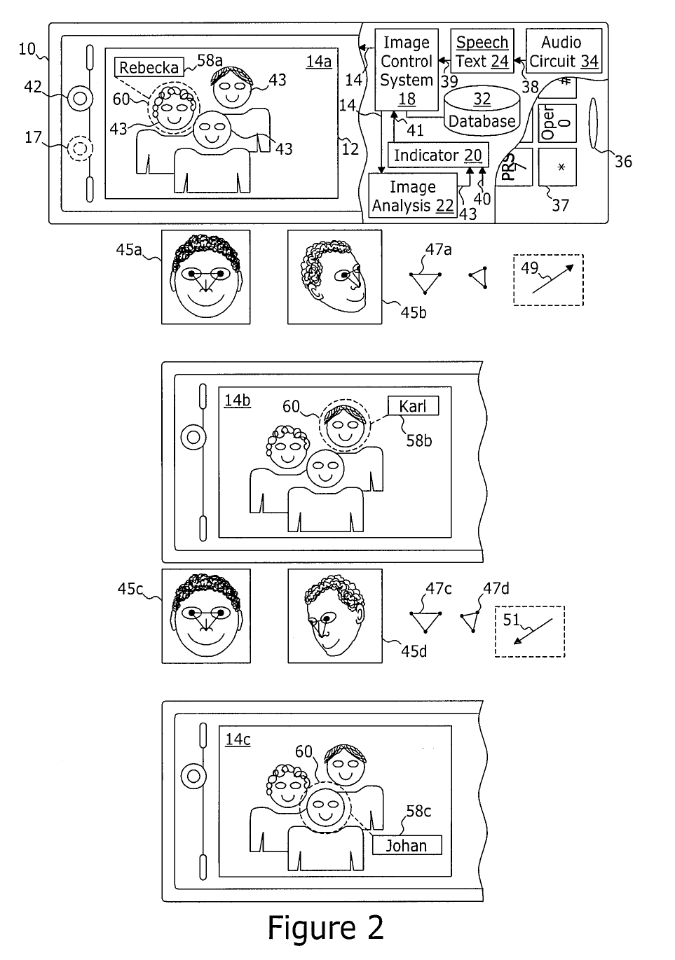

In the example represented by FIG. 1, the selection criteria may be criteria for determining the existence of objects commonly tagged in photographs such as people, houses, dogs, or even the existence of an object in an otherwise unadorned area of the digital image 15. Unadorned area, such as the sky or the sea as depicted in the upper segments or the center right segment would not meet the selection criteria. Referring briefly to FIG. 2, the selection criteria may be criteria for determining the existence of people, and in particular people's faces, within the digital image 14.

Returning to FIG. 1, the indicator module 20 (receiving a representation of the discrete portions 43 identified by the image analysis module 22) may: i) drive rendering of an indicator 41 (such as hatching or highlighting as depicted in rendering 15a) indicating a discrete portion 43 (unlabeled on rendering 15a) of the digital image as identified by the image analysis module 22; and ii) moving, or snapping, such indicator 41 to a different discrete portion 43 of the digital image (as depicted in renderings 15b and 15c) to enable user selection of a selected portion for manipulation.

To implement moving, or snapping the indicator 41 between each discrete portion 43 of the digital image, the indicator module 20 may be coupled to a user monitor digital camera 42. The user monitor digital camera 42 may have a field of view directed towards the user such that when the user is viewing the display screen 12, motion detected within a sequence of images (or motion video) 40 output by the user monitor digital camera 42 may be used for driving the moving or snapping of the indicator 41 between each discreet portion.

In one example, the motion detected within the sequence of images (or motion video) 40 may be motion of an object determined by means of object recognition, edge detection, silhouette recognition or other means for detecting motion of any item or object detected within such sequence of images.

In another example, the motion detected within the sequence of images (or motion video) 40 may be motion of the user's eyes utilizing eye tracking or gaze detection systems. For example, reflections of illumination off the user's cornea may be utilized to determine where on the display screen 12 the user has focused and/or a change in position of the user's focus on the display screen 12. In general, the indicator module 20 monitors the sequence of images 40 provided by the user monitor digital camera 42 and, upon detecting a qualified motion, generates a direction vector representative of the direction of such motion and repositions the indicator 41 to one of the discrete portions 43 that is, with respect to its current position, in the direction of the direction vector.

In one embodiment, the user monitor digital camera 42 may have a field of view directed towards the face of the user such that the sequence of images provided to the indicator module include images of the user's face as depicted in thumbnail frames 45a-45d.

In this embodiment, the indicator module 20 monitors the sequence of thumbnail frames 45a-45d provided by the user monitor digital camera 42 and, upon detecting a qualified motion of at least a portion of the user's face, generates a direction vector representative of the direction of such motion and repositions the indicator 41 to one of the discrete portions 43 that is, with respect to its current position, in the direction of the direction vector.

For example, as represented in FIG. 1, the digital image 15 may be segmented into nine (9) segments by dividing the digital image 15 vertically into thirds and horizontally into thirds. After processing by the image analysis module 22, those segments (of the nine (9) segments) which meet selection criteria are deemed discrete portions 43. In this example, the left center segment including an image of a house (label 43 has been omitted for clarity of the Figure), the center segment including an image of a boat, the left lower segment including an image of a dog, and the right lower segment including an image of a person may meet selection criteria and be discrete portions 43. The remaining segments include only unadorned sea or sky and may not meet selection criteria. As represented by rendering 15a, the indicator 41 is initially positioned at the left center discrete portion.

As discussed, to reposition the indicator 41, the indicator module 20 may receive the sequence of images (which may be motion video) 40 from the user monitor digital camera 42 and move, or snap, the indicator 41 between discrete portions 43 in accordance with motion of at least a portion of the user's face as detected in the sequence of images 40.

For example, when the user, as imaged by the user monitor digital camera 42 and depicted in thumbnail frame 45a, turns his head to the right as depicted in thumbnail frame 45b, the indicator module 20 may define a direction vector 49 corresponding to the direction of motion of at least a portion of the user's face.

In this example, the portion of the user's face may comprise motion of the user's two eyes and nose—each of which is a facial feature that can be easily distinguished within an image (e.g. distinguished with fairly simple algorithms requiring relatively little processing power). In more detail, the vector 49 may be derived from determining the relative displacement and distortion of a triangle formed by the relative position of the users' eyes and nose tip within the image. For example, triangle 47a represents the relative positions of the user's eyes and nose within frame 45a and triangle 47b represents the relative position of the user's eyes and nose within frame 45b. The relative displacement between triangle 47a and 47b along with the relative distortion indicate the user has looked to the right and upward as represented by vector 49.

In response to determining vector 49, the indicator module 20 may move, or snap, the indicator 41 to a second item of interest depicted within the digital image 15 that, with respect to the initial position of the indicator 41 (at the center right position as depicted in rendering 15a), is in the direction of the vector 49—resulting in application of the indicator 41 to the center of the digital image as depicted in rendering 15b.

It should be appreciated that if each of the nine (9) segments represented a discrete portion, there would exists ambiguity because overlaying vector 49 on digital image 15 indicates that the movement of the indicator 41 (from the center right position as depicted in rendering 15a) could be to the upper center portion of the digital image, the center portion of the digital image, or the upper right portion of the digital image. However, by first utilizing the image analysis module 22 to identify only those segments meeting selection criteria (and thereby being a discrete portion 43), only those segments (of the nine (9) segments) which depict objects other than unadorned area represent discrete portions 43. As such, there is little ambiguity that only the center portion is displaced from the center right portion in the direction of the direction vector 49. As such, the motion represented by displacement of the user's face between frame 45a to 45b (resulting in vector 49) results in movement of, or snapping of, the indicator 41 to the center as represented in rendering 15b.

Similarly, when the user, as depicted in thumbnail frame 45c, turns his head downward to the left as depicted in thumbnail frame 45d, the indicator module 20 may calculate a direction vector 51 corresponding to the direction of the motion of the user's face. Based on vector 51, the indicator module 20 may move the indicator 41 in the direction of vector 51 which is to the lower left of the digital image.

When the indicator 41 is in a particular position, such as the center left as represented by rendering 15a, the user may manipulate that selected portion of the digital image. An exemplary manipulation implemented by the image control system 18 may comprise adding, or modifying, a text tag 59. Examples of the text tags 59 comprise: i) text tag 59a comprising the word “House” as shown in rendering 15a of the digital image 15; ii) text tag 59b comprising the word “Boat” as shown in rendering 15b; and iii) text tag 59c comprising the word “Dog” as shown in rendering 15c.

To facilitate adding and associating a text tag 59 with a discrete portion 43 of the digital image 15, the image control system 18 may interface with the speech to text module 24. The speech to text module 24 may interface with an audio circuit 34. The audio circuit 34 generates an audio signal 38 representing words spoken by the user as detected by a microphone 36. In an exemplary embodiment, a key 37 on the mobile device may be used to activate the audio circuit 34 to capture spoken words uttered by the user and generate the audio signal 38 representing the spoken words. The speech to text module 24 may perform speech recognition to a generate text representation 39 of the words spoken by the users. The text 39 is provided to the image control system 18 which manipulates the digital image 15 by placement of the text 39, as the text tag 59a. As such, if the user utters the word “house” while depressing key 37, the text of “house” will be associated with the position as a text tag.

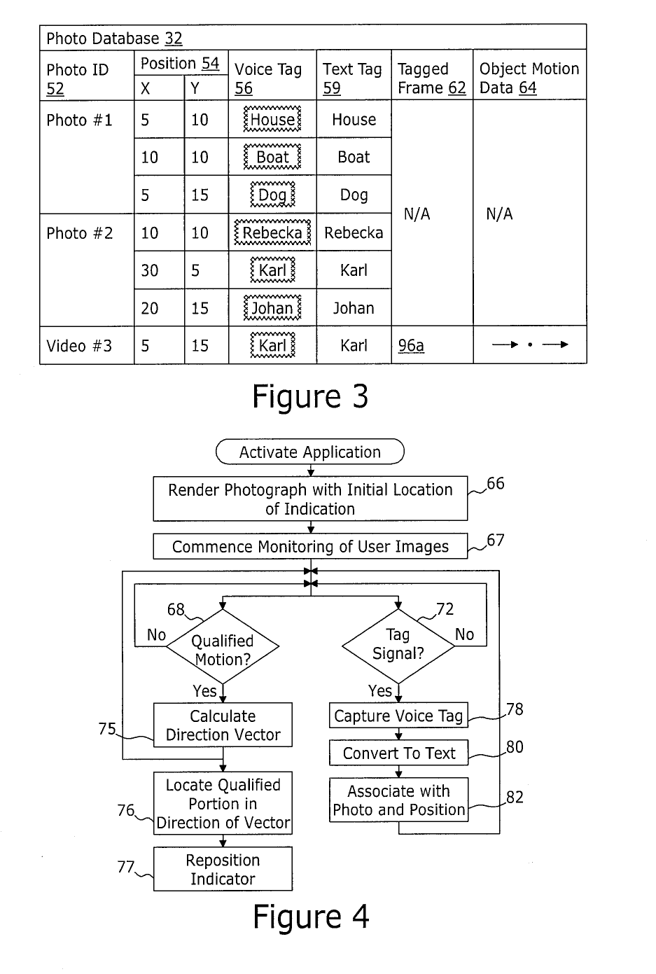

Turning briefly to the table of FIG. 3, an exemplary database 32 associates, to each of a plurality of photographs identified by a Photo ID indicator 52, various text tags 59. Each text tag 59 is associated with its applicable position 54 (for example, as defined by X,Y coordinates) within the photograph. Further, in the example wherein the text tag 59 is created by capture of the user's spoken words and conversion to a text tag, the audio signal representing the spoken words may also be associated with the applicable position 54 within the digital image as a voice tag 56.

Turning to FIG. 2, a second exemplary aspect is shown with respect to a digital image 14 depicting several people. As discussed, selection criteria may include criteria for determining the existence of people, and in particular people's faces, within the digital image 14. As such, each person depicted within the digital image 14, or more specifically the face of each person depicted within the digital image 15, may be a discrete portion 43.

Again, the indicator module 20 renders an indicator 60 (which in this example may be a circle or highlighted halo around the person's face) at one of the discrete portions 43. Again, to move location of the indicator 60 to other discrete portions 43 (e.g. other people), the indicator module 20 may receive the sequence of images (which may be motion video) 40 from the user monitor digital camera 42 and move the location of the indicator 60 between discrete portions 43 in accordance with motion detected in the sequence of images 40.

Again, the motion detected within the sequence of images (or motion video) 40 may be motion of an object determined by means of object recognition, edge detection, silhouette recognition or other means for detecting motion of any item or object detected within such sequence of images.

Again, the indicator module 20 monitors the sequence of images 40 provided by the user monitor digital camera 42 and, upon detecting a qualified motion, generates a direction vector representative of the direction of such motion and repositions the indicator 41 to one of the discrete portions 43 that is, with respect to its current position, in the direction of the direction vector.

Again, in one embodiment, the user monitor digital camera 42 may have a field of view directed towards the face of the user such that the sequence of images provided to the indicator module include images of the user's face as depicted in thumbnail frames 45a-45d.

Again, when the user, as depicted in thumbnail image 45a, turns his head to the right as depicted in thumbnail image 45b, the indicator module 20 may define vector 49 corresponding to the direction of the motion of the user's face in the same manner as discussed with respect to FIG. 1.

In response to determining vector 49, the indicator module 20 may move, or snap, the indicator 60 to a second item of interest depicted within the digital image 14 that, with respect to the initial position of indicator 60 (as depicted in rendering 14a), in the direction of the vector 49—resulting in application of the indicator 60 as depicted in rendering 14b.

Similarly, when the user, as depicted in thumbnail image 45c, turns his head downward to the left as depicted in thumbnail image 45d, the indicator module 20 may define vector 51 corresponding to the direction of the motion of the user's face.

In response to determining vector 51, the indicator module 20 may move, or snap, the indicator 60 to a next discrete portion 43 within the digital image 14 that, with respect to the previous position of 60 (as depicted in rendering 14b), in the direction of the vector 51—resulting in application of the indicator 60 as depicted in rendering 14c. It should be appreciated in the example depicted in FIG. 2, both “Rebecka” as depicted in rendering 14a and “Johan” as depicted in rendering 14c are both generally in the direction of vector 51 with respect to “Karl” as depicted in rendering 14b. Ambiguity as to whether the indicator 60 should be relocated to “Rebecka” or “Johan” is resolved by determining which of the two (as discrete portions 43 of the digital image 14), with respect to “Johan” is most closely in the direction of vector 51.

Again, in each instance wherein the indicator 60 is in a particular position, the user may manipulate that selected portion of the digital image 14 such as by initiation operation of a red-eye correction algorithm or adding, or modifying, a text tag 58. The image control system 18 provides for adding, or modifying, a text tag in the same manner as discussed with respect to FIG. 1.

The flow chart of FIG. 4 represents exemplary steps performed in an exemplary implementation of the present invention. Turning to FIG. 4 in conjunction with FIG. 2, step 66 may represent the image control system 18 rendering of the digital image 14 on the display screen 12 with an initial location of the indicator 60 as represented by rendering 14a.

Once rendered, the indicator module 20 commences, at step 67, monitoring of the sequence of images (which may be motion video) 40 from the user monitor digital camera 42.

While the indicator module 20 is monitoring the sequence of images 40, the user may: i) initiate manipulation (by the image control system 18) of the discrete portion 43 of the digital image at which the indicator 60 is located; or ii) move his or her head in a manner to initiate movement (by the indicator module 20) of the indicator 60 to a different discrete portion 43 within the digital image. Monitoring the sequence of images 40 and waiting for either such events are represented by the loops formed by decision box 72 and decision box 68.

In the event the user initiates manipulation, as represented by indicating application of a text tag at decision box 72, steps 78 through 82 are preformed for purposes of manipulating the digital image to associate a text tag with the discrete portion 43 of the digital image at which the indicator 60 is located. In more detail, step 78 represents capturing the user's voice via the microphone and audio circuit 33. Step 80 represents the speech to text module 24 converting the audio signal to text for application as the text tag 58. Step 82 represents the image control system 18 associating the text tag 58, and optionally the audio signal representing the user's voice as the voice tag 56, with the discrete portion 43 of the digital image 14. The association may be recorded, with the digital image 14, in the photo database 32 as discussed with respect to FIG. 3.

In the event the user moves his or her head in a manner to initiate movement of the indicator 60, as represented by decision box 68, steps 75 though 77 may be performed by the indicator module 20 for purposes of repositioning the indicator 60. In more detail, upon the indicator module 20 detecting motion (within the sequence of images 40) qualifying for movement of the indicator 60, the indicator module 20 calculates the direction vector as discussed with respect to FIG. 2 at step 75.

Step 76 represents locating a qualified discrete portion 43 within the digital image in the direction of the direction vector. Locating a qualified discrete portion 43 may comprise: i) locating a discrete portion 43 that is, with respect to the then current location of the indicator, in the direction of the vector; ii) disambiguating multiple discrete portions 43 that are in the direction of the vector by selecting the discrete portion 43 that is most closely in the direction of the vector (as discussed with respect to movement of the indicator between rendering 14b and 14c with respect to FIG. 2); and/or iii) disambiguating multiple discrete portions 43 that are in the direction of the vector by selecting the discrete portion 43 that includes an object matching predetermined criteria, for example an image with characteristics that indicating it is an item of interest typically selected for text tagging. Step 77 represents repositioning the indicator 60.

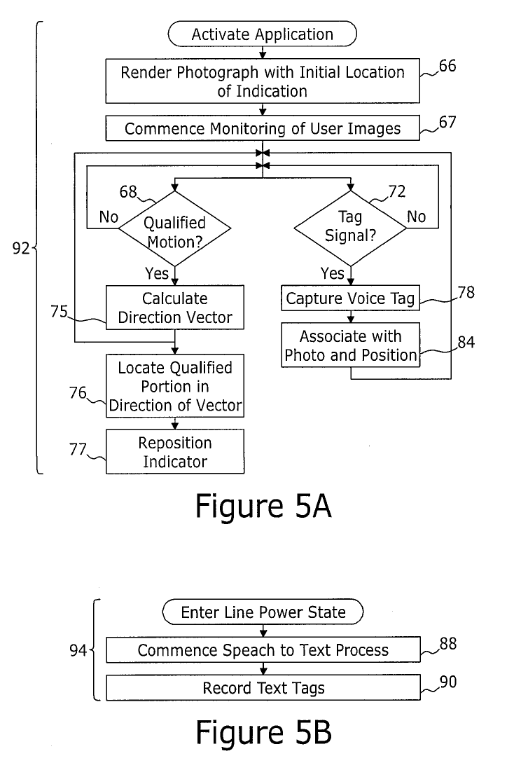

FIGS. 5a and 5b represent an alternative embodiment of operation useful for implementation in a battery powered device. In more detail, FIG. 5a represents exemplary steps that may be performed while the device is operating an a battery powered state 92 and FIG. 5b represents exemplary steps that may be performed only when the device is operating in a line powered state 94 (e.g. plugged in for batter charging).

When operating in the battery powered state 92, the functions may be the same as discussed with respect to FIG. 4 except that voice to text conversion is not performed. Instead, as represented by step 84 (following capture of the user's voice), the audio signal 38 only (for example a 10 second captured audio clip) is associated with the discrete portion 43 of the digital image in the photo database 32. At some later time when the device is operating in the line powered state 94, the speech to text module 22 may perform a batch process of converting speech to text (step 88) and the image control system 18 may apply and associate such text as a text tag in the database 32 (step 90).

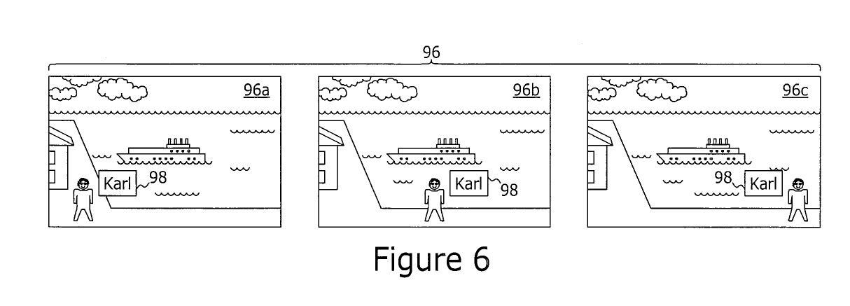

Turning to FIG. 6, yet an application of the present invention to motion video 96. The exemplary motion video 96 comprises a plurality of frames 96a, 96b, and 96c—which may be frames of a motion video clip, stored in the database 32 or may be real-time frames generated by the camera (e.g. viewfinder).

In generally, utilizing the teachings as described with respect to FIG. 2 and FIG. 4, a text tag 98 may be added to one of the frames (for example frame 96a). Such text tag 98 may then be recorded in the database 32 as discussed with respect to FIG. 3, with the exception that because frame 96a is part of motion video, additional information is recorded. For example, identification of frame 96a is recorded as the “tagged frame” 62 and subsequent motion of the portion of the image that was tagged (e.g. the depiction of Karl) is recorded as object motion data 64. As such, when subsequent frames 96b or 96c of the video clip 96 are rendered, the image analysis module recognizes the same depiction in such subsequent frames and the text tag 98 remains with the portion of the image originally tagged—even as that portion is relocated with in the frame. The text tag 98 “follows” Karl throughout the video. This functionality, amongst other things, enables information within the motion video to be searched. For example, a tagged person may be searched within the entire video clip—or within multiple stored pictures or video clips.

In another aspect, the diagrams 96a, 96b, 96c of FIG. 6 may be a sequence of still images such as several digital images captured in a row. Again, a text tag 98 may be added to one of the frames (for example frame 96a). Such text tag 98 may be recorded in the database 32. The image analysis module 22 may locate the same image depicted in subsequence digital images 96b, 96c. As such, the image may be automatically tagged in the subsequent images 96b, 96c.

Although the invention has been shown and described with respect to certain preferred embodiments, it is obvious that equivalents and modifications will occur to others skilled in the art upon the reading and understanding of the specification.

As one example, the exemplary manipulations discussed include application of a red-eye removal function and addition of text tags, it is envisioned that any other digital image manipulation function available in typical digital image management applications may be applied to a digital image utilizing the teachings described herein.

As another example, the exemplary image 15 depicted in FIG. 1 and image 14 depicted FIG. 2 are a single digital image (either photograph or motion video). However, it is envisioned that the image rendered on the display screen 12 may be multiple “thumb-nail” images, each representing a digital image (either photograph or motion video). As such, each portion of the image may represent one of the “thumb-nail”images and the addition or tagging of text or captured audio to the “thumb-nail” may effect tagging such text or captured audio to the photograph or motion video represented by the “thumb-nail”. The present invention includes all such equivalents and modifications, and is limited only by the scope of the following claims.

1. A system for enabling a user viewing a digital image rendered on a display screen to select a discrete portion of a digital image for manipulation, the system comprising:
the display screen;
an image control system driving rendering of the digital image on the display screen;
an image analysis module determining a plurality of discrete portions of the digital image which may be subject to manipulation;
a user monitor digital camera having a field of view directed towards the user; and
a indicator module receiving a sequence of images from the user monitor digital camera and driving repositioning an indicator between the plurality of discrete portions of the digital image in accordance with motion detected from the sequence of images.

2. The system of claim 1, wherein:
the user monitor digital camera has a field of view directed towards the user's face; and
the indicator module drives repositioning of the indicator between the plurality of discrete portions of the digital image in accordance with motion of at least a portion of the user's face as detected from the sequence of images.

3. The system of claim 1, wherein repositioning an indicator between the plurality of discrete portions comprises:
determining a direction vector corresponding to a direction of the detected motion; and
snapping the indicator from a first of the discrete portions to a second of the discrete portions wherein the second of the discrete portions is positioned, with respect to the first of the discrete portions, in the same direction as the direction vector.

4. The system of claim 3, wherein:
each of the discrete portions of the digital image comprises an image depicted within the digital image meeting selection criteria; and
determining the plurality of discrete portions of the digital image comprises initiating an image analysis function to identify, within the digital image, each image meeting the selection criteria.

5. The system of claim 4, wherein:
the selection criteria is facial recognition criteria such that each of the discrete portions the digital image includes a facial image of a person.

6. The system of claim 5, wherein the image control system further:
obtains user input of a manipulation to apply to a selected portion of the digital image, the selected portion of the digital image being the one of the plurality of discrete portions identified by the indicator at the time of obtaining user input of the manipulation; and
applying the manipulation to the digital image.

7. The system of claim 6, wherein the manipulation is correction red-eye on the facial image of the person within the selected portion.

8. The system of claim 6, wherein the manipulation comprises application of a text tag to the image of the person within the selected portion of the digital image.

9. The system of claim 6, wherein:
the digital image is a portion of a motion video clip; and
the manipulation applied to the image meeting selection criteria is remains associated with the same image in subsequent portions of the motion video, whereby such image meeting the selection criteria may be searched within the motion video clip.

10. The system of claim 1, wherein the image control system further:
obtains user input of a text tag to apply to a selected portion of the digital image, the selected portion of the digital image being the one of the plurality of discrete portions identified by the indicator at the time of obtaining user input of the manipulation; and
associates the text tag with the selection portion of the digital image.

11. The system of claim 10:
wherein the system further comprises:
an audio circuit for generating an audio signal representing words spoken by the user; and
a speech to text module receiving at least a portion of the audio signal and generating a text representation of words spoken by the user; and
the text tag comprises such text representation.

12. The system of claim 11:
wherein the system is embodied in a battery powered device which operates in both a battery powered state and a line powered state;
if the system is in the battery powered state when receiving at least a portion of the audio signal representing words spoken by the user, then such portion of the audio signal is saved in the database; and
when the system is in the line powered state:
the speech to text module obtains the portion of the audio signal from the database and generates a text representation of the words spoken by the user; and
the image control system 18 applies the text representation as the text tag.

13. A method of operating a system for enabling a user viewing a digital image rendered on a display screen to select a discrete portion of a digital image for manipulation, the method comprising:
rendering the digital image on the display screen;
analyzing the digital image to determine a plurality of discrete portions of the digital image which may be subject to manipulation;
receiving a sequence of images from a user monitor digital camera and repositioning an indicator between the plurality of discrete portions of the digital image in accordance with motion detected from the sequence of images.

14. The method of claim 13, wherein:
the sequence of images from the user monitor digital camera comprises a sequence of images of the user's face; and
repositioning the indicator between the plurality of discrete portions of the digital image is in accordance with motion of at least a portion of the user's face as detected from the sequence of images.

15. The method of claim 13, wherein repositioning an indicator between the plurality of discrete portions comprises:
determining a direction vector corresponding to a direction of the detected motion; and
snapping the indicator from a first of the discrete portions to a second of the discrete portions wherein the second of the discrete portions is positioned, with respect to the first of the discrete portions, in the same direction as the direction vector.

16. The method of claim 15, wherein:
each of the discrete portions of the digital image comprises an image depicted within the digital image meeting selection criteria; and
determining the plurality of discrete portions of the digital image comprises initiating an image analysis function to identify, within the digital image, each image meeting the selection criteria.

17. The method of claim 16, wherein:
the selection criteria is facial recognition criteria such that each of the discrete portions the digital image is a facial image of a person.

18. The method of claim 13, further comprising:
obtaining user input of a text tag to apply to a selected portion of the digital image, the selected portion of the digital image being the one of the plurality of discrete portions identified by the indicator at the time of obtaining user input of the manipulation; and
associating the text tag with the selection portion of the digital image.

19. The method of claim 18:
further comprising generating an audio signal representing words spoken by the user as detected by a microphone; and,
wherein associating the text tag with the selected portion of the digital image comprises performing speech recognition on the audio signal to generate a text representation of the words spoken by the user; and
the text tag comprises the text representation of the words spoken by the user.

20. The method of claim 19, wherein the method is implemented in a battery powered device which operates in both a battery powered state and a line powered state, the method comprising:
if the system is in the battery powered state when receiving at least a portion of the audio signal representing words spoken by the user, then saving such portion of the audio signal; and
when the system is in the line powered state:
generating a text representation of the saved audio signal; and
associating the text representation with the selected portion of the digital image, as the text tag.
